(19) United States
(12) Patent Application Publication
(10) Pub. No.: US 2026/0340019 A1
(43) Pub. Date: Oct. 29, 2026

(54) LOG PROCESSING METHOD, LOG PROCESSING SYSTEM AND COMPUTER-READABLE RECORDING MEDIUM

(71) Applicant: LITE-ON TECHNOLOGY CORPORATION, Taipei (TW)

(72) Inventors: Lie-Wei WU, Taipei (TW); Ming-Ting LIN, Taipei (TW); Ming-Yi LIAO, Taipei (TW)

(21) Appl. No.: 19/529,187

(22) Filed: Feb. 4, 2026

Related U.S. Application Data
(60) Provisional application No. 63/793,745, filed on Apr. 24, 2025.

(30) Foreign Application Priority Data
Dec. 26, 2025 (CN) 202511985782.3

(51) Int. Cl. G06F 16/35; G06F 40/205

(52) U.S. Cl. CPC G06F 16/35; G06F 40/205

(57) ABSTRACT

A log processing method, a log processing system and a non-transitory computer-readable recording medium are provided. The log processing method includes the following steps. A plurality of raw log entries are continuously obtained. The raw log entries originate from a plurality of sources. The raw log entries are clustered into one or more groups. The raw log entries are sequentially inputted into a log parsing engine to output a plurality of normalized log entries. For each of the groups, a plurality of security ranks recorded in the normalized log entries are identical to each other and a plurality of security descriptions recorded in the normalized log entries are identical to each other. The normalized log entries are stored in a log search engine.

This application claims the benefit of U.S. Provisional application Ser. No. 63/793,745, filed Apr. 24, 2025, and China application Serial No. 202511985782.3, filed Dec. 26, 2025, the disclosure of which is incorporated by reference herein in its entirety.

### TECHNICAL FIELD

The disclosure relates in general to a digital processing method and a digital processing system, and more particularly to a log processing method, a log processing system and a non-transitory computer-readable recording medium.

### BACKGROUND

In the current field of cybersecurity, log analysis is a crucial step in maintaining system stability and security. However, traditional log analysis processes often face the following challenges.

Logs from multiple sources require manual parsing of their formats. Different systems generate logs with varying formats. Modern log management software primarily addresses log formatting needs by establishing log processing rules and combining them with different log processing plugins, ultimately producing a regularized format. This method requires significant manpower and time to understand the source log formats and to combine plugins and rules accordingly to finally generate a log format suitable for analysis.

The Security Information and Event Management (SIEM) system often suffers from false alarms. Existing log processing system may lose some log information during processing and struggle to flexibly handle logs from multiple sources, varying formats, and correlate logs from different sources. This forces cybersecurity personnel to spend significant time sifting through numerous false alarms to find underlying security incidents.

### SUMMARY

This disclosure is directed to a log processing method, a log processing system, and a non-transitory computer-readable recording medium. It utilizes clustering and normalization technologies to enable hierarchical searching and analysis of multi-source logs according to the security rank, significantly improving log processing efficiency and consistency, while reducing false positive rates and enhancing cybersecurity analysis capabilities.

According to one embodiment, a log processing method is provided. The log processing method includes the following steps. A plurality of raw log entries are continuously obtained. The raw log entries originate from a plurality of sources. The raw log entries are clustered into one or more groups. The raw log entries are sequentially inputted into a log parsing engine to output a plurality of normalized log entries. For each of the groups, a plurality of security ranks recorded in the normalized log entries are identical to each other and a plurality of security descriptions recorded in the normalized log entries are identical to each other. The normalized log entries are stored in a log search engine.

According to another embodiment, a log processing system is provided. The log processing system includes an input unit, a cluster unit, a log parsing engine and a log search engine. The input unit is configured to continuously obtain a plurality of raw log entries. The raw log entries originate from a plurality of sources. The cluster unit is configured to cluster the raw log entries into one or more groups. The log parsing engine is configured to sequentially input the raw log entries into a log parsing engine to output a plurality of normalized log entries. For each of the groups, a plurality of security ranks recorded in the normalized log entries are identical to each other and a plurality of security descriptions recorded in the normalized log entries are identical to each other. The log search engine is configured to store the normalized log entries.

According to an alternative embodiment, a non-transitory computer readable medium is provided. The non-transitory computer readable medium stores a plurality of program instructions that, when executed by a processor, cause the processor to perform a method including the following steps. A plurality of raw log entries are continuously obtained. The raw log entries originate from a plurality of sources. The raw log entries are clustered into one or more groups. The raw log entries are sequentially inputted into a log parsing engine to output a plurality of normalized log entries. For each of the groups, a plurality of security ranks recorded in the normalized log entries are identical to each other and a plurality of security descriptions recorded in the normalized log entries are identical to each other. The normalized log entries are stored in a log search engine.

### BRIEF DESCRIPTION OF THE DRAWINGS

FIG. 1 illustrates a log processing system and a plurality of electronic devices according to an embodiment of this disclosure.

FIG. 2 illustrates a block diagram of the log processing system according to an embodiment of this disclosure.

FIG. 3 illustrates a flowchart of a log processing method according to an embodiment of this disclosure.

FIG. 4 illustrates the dynamic adjustment of the predetermined time and the predetermined quantity.

FIGS. 5A to 5C illustrate a detailed flowchart of the step S120 according to an embodiment of this disclosure.

FIG. 6 illustrates a detailed flowchart of the step S130 according to an embodiment of this disclosure.

FIG. 7 illustrates the format of the normalized log entries.

FIG. 8 illustrates the hierarchical structure of normalized log entries.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

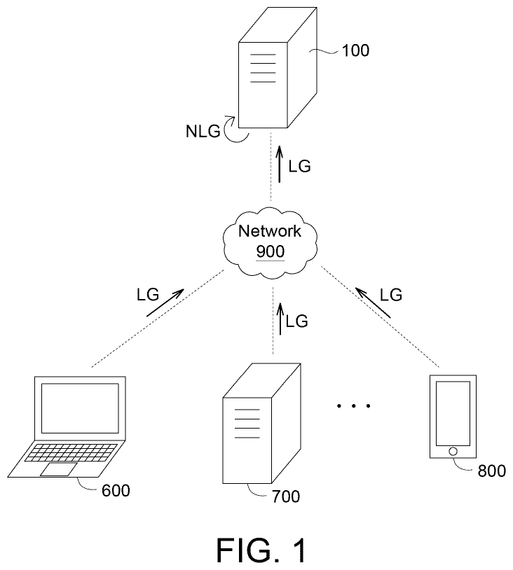

Please refer to FIG. 1, which illustrates a log processing system 100 and a plurality of electronic devices 600, 700, and 800 according to an embodiment of this disclosure. The log processing system 100 receives a plurality of raw log entries LG from various sources, such as the electronic devices 600, 700, and 800, via the network 900. The raw log entries LG may use Syslog, Zeek conn.log, AWS JSON, or Apache (Common Log Format/Combined Log Format) formats. Syslog is a common log protocol/format, typically used in Linux, Unix, firewalls, routers, etc. Zeek conn.log is a structured plain text format (tab-delimited) and is typically used in Zeek network monitoring and threat detection tools. AWS JSON is a JSON format and is typically used in AWS CloudTrail (for API activities), AWS VPC Flow Logs (network traffic), or AWS WAF Logs (Web Application Firewall). Apache is a plain text format and is typically used in Apache HTTP Server.

In this disclosure, the log processing system 100 could utilize clustering and normalization techniques to cluster and normalize the raw log entries LG from multiple sources into a plurality of normalized log entries NLG. The normalized log entries NLG could be hierarchically searched and analyzed according to the security rank, significantly improving log processing efficiency and consistency, and reducing false positive rates while enhancing cybersecurity analysis capabilities.

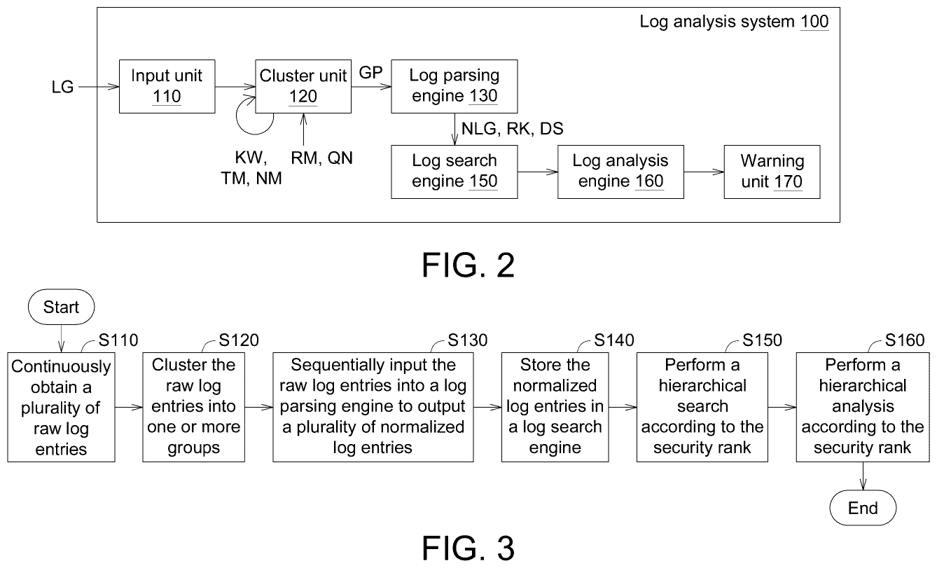

Please refer to FIG. 2, which illustrates a block diagram of the log processing system 100 according to an embodiment of this disclosure. The log processing system 100 includes an input unit 110, a cluster unit 120, a log parsing engine 130, a log search engine 150, a log analysis engine 160, and a warning unit 170. The input unit 110 is used to receive data, such as a wireless network module, a wired network module, or a connection cable. The cluster unit 120 is used for data clustering. The log parsing engine 130 is used for log parsing. The log search engine 150 is used for log searching. The log analysis engine 160 is used for log analysis.

The cluster unit 120, the log parsing engine 130, the log search engine 150 and/or the log analysis engine 160 are, for example, a circuit, a circuit board, a storage device for storing code, or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The warning unit 170 is used to issue an alarm when an anomaly is detected, such as a warning light, a warning horn, or a message transmission module.

In this disclosure, the cluster unit 120 could cluster the raw log entries LG from multiple sources, and the log parsing engine 130 performs the normalization processing to obtain the normalized log entries NLG. The normalized log entries NLG are simultaneously parsed to obtain a corresponding security rank RK and a security description DS, enabling these normalized log entries NLG to be hierarchically searched and analyzed according to the security rank RK. This significantly improves log processing efficiency and consistency, and reduces false positive rates while enhancing security analysis capabilities. A flowchart is provided below to explain in detail the operation of each component.

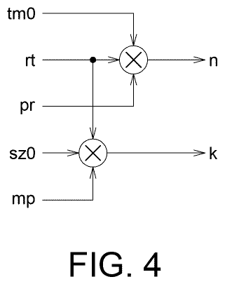

Please refer to FIG. 3, which illustrates a flowchart of a log processing method according to an embodiment of this disclosure. The log processing method is executed, for example, by a computer, chip, or computer-readable recording medium loaded with program code. The log processing method includes, for example, steps S110 to S160.

In the step S110 of FIG. 3, as shown in FIGS. 1 and 2, the input unit 110 continuously obtains the raw log entries LG. The raw log entries LG originate from several different sources, such as the electronic devices 600, 700, and 800 in FIG. 1. The formats of the raw log entries LG from different sources may not be exactly the same.

Next, in the step S120 of FIG. 3, as shown in FIG. 2, the cluster unit 120 clusters the raw log entries LG into one or more groups GP. In one embodiment, more than one raw log entry LG may be clustered into one group GP. Alternatively, a single raw log entry LG may be clustered into one group GP. The raw log entries LG that are clustered in the same group GP, for example, originate from the same source (e.g., the same IP address).

According to various cluster trigger conditions, after receiving one or more raw log entries LG, the cluster unit 120 will trigger cluster actions once the cluster trigger conditions are met. The cluster trigger conditions include, for example, “emergency trigger,” “stress trigger,” “idle trigger,” “time trigger,” and “quantity trigger.” The priority order of the cluster trigger conditions is, for example, “urgent trigger,” “stress trigger,” “idle trigger,” “time trigger,” and “quantity trigger”; or “urgent trigger,” “stress trigger,” “idle trigger,” “quantity trigger,” and “time trigger.”

The clustering trigger condition for “emergency trigger” is that an emergency keyword such as “CRITICAL”, “ALERT”, “ATTACK”, and “BREACH” appears. Once any emergency keywords appear, the raw log entries LG are immediately clustered into one group GP.

The clustering trigger condition for “stress trigger” is, for example, that a memory utilization RM is larger than a predetermined threshold. This predetermined threshold could be, for example, 70%, 80%, or 90%. Once the memory utilization RM is larger than the predetermined threshold, the raw log entries LG are clustered into one group GP.

The clustering trigger condition for “idle trigger” is, for example, that a queue count QN of the log parsing engine 130 is less than a predetermined count. The predetermined count is, for example, 1 or 2. Once the queue count QN of the log parsing engine 130 is less than the predetermined count, these raw log entries LG are clustered into one group GP.

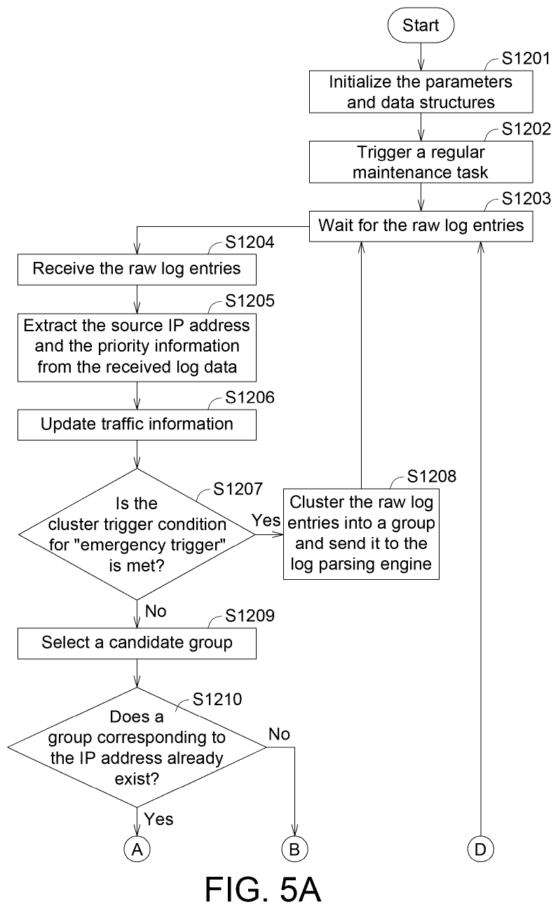

The triggering condition for “time-triggered” is, for example, that a waiting time TM of the raw log entries LG is larger than a predetermined time n. The predetermined time n is, for example, a dynamically adjusted value. Please refer to FIG. 4, which illustrates the dynamic adjustment of the predetermined time n and the predetermined quantity k. The predetermined time n is, for example, dynamically adjusted according to the following formula (1), according to a waiting time base tm0, a flow rate coefficient rt, and a priority coefficient pr.

n=tm0×(1+rt−pr) (1)

The waiting time base tm0 is, for example, 3 seconds. The flow rate coefficient rt is used to adjust the predetermined time n according to the current flow of raw log entries LG, in order to improve the processing throughput under high flow conditions.

The priority coefficient pr is used to shorten the processing delay according to the importance of the event, allowing the system to prioritize raw log entries LG with higher security risks.

The cluster trigger condition for “quantity trigger” is, for example, that the waiting quantity NM of the raw log entries LG is larger than a predetermined quantity k. The predetermined quantity k is, for example, a dynamically adjusted value. As shown in FIG. 4, the predetermined quantity k is, for example, dynamically adjusted according to the following formula (2), according to a batch size base sz0, a flow rate coefficient rt, and a memory stress coefficient mp.

k=sz0×(1+rt−mp) (2)

The batch size base sz0 is, for example, 30 entries. The flow rate coefficient rt is used to adjust the predetermined time n according to the current flow of the raw log entries LG, in order to improve the processing throughput under high flow conditions.

The memory stress coefficient mp is used to control the batch size according to the memory usage, preventing the system from exhausting resources during peak load periods.

As shown in FIG. 4, to cope with the highly variable log traffic and system resource status, the flow rate coefficient rt, the priority coefficient pr, and the memory stress coefficient mp are adjusted in real time according to the system's input intensity, task urgency, and resource pressure, respectively. Through modular coupling design, an adaptive, flexible, and predictable log processing control logic is achieved. The combination of these three could dynamically and with boundary control allocate resources according to different operating scenarios, effectively improving system stability and the ability to respond to cybersecurity incidents in a timely manner, while also taking into account high concurrency processing efficiency and false alarm rate suppression.

The flow rate coefficient rt could range from −0.8 to 2.0. At high flow rates (e.g., larger than 30 transactions per 3 seconds), the flow rate coefficient rt could be set to 1.5. At low flow rates (e.g., less than 5 transactions per 3 seconds), the flow rate coefficient rt could be set to −0.5. At medium flow rates, the flow rate coefficient rt could be set to 0. By designing the flow rate coefficient rt, at high flow rates, batch sizes could be increased to shorten processing time; at low flow rates, batch sizes could be decreased to extend processing time.

The priority coefficient pr ranges from 0 to 0.9. For high-priority raw log entries LG, the priority coefficient pr could be set to 0.6; for general raw log entries LG, the priority coefficient pr could be set to 0. The priority coefficient pr affects the predetermined time n of the “time-triggered” event, allowing high-priority raw log entries LG to shorten their waiting time.

The memory stress coefficient mp ranges from −0.5 to 1.0. The memory stress coefficient mp is defined according to the following algorithm: total_logs represents the total number of logs across all groups, and memory_pressure_factor represents the memory stress coefficient mp.

```
IF total_logs > 8000 THEN
  pressure = (total_logs − 8000) / (10000 − 8000)
  memory_pressure_factor = min(1.0, pressure × 0.8)
ELSE
  memory_pressure_factor = 0
```

The memory stress coefficient mp affects the predetermined quantity k of the “quantity trigger”. By designing the memory stress coefficient mp, the batch size could be increased to speed up processing when memory stress increases.

Furthermore, the predetermined time n and the predetermined quantity k could be set according to the boundary constraints of equations (3) and (4) to prevent extreme cases.

predetermined time n=max(3,min(30,predetermined time n)) (3)

That is, the predetermined time n is limited to between 3 seconds and 30 seconds.

predetermined quantity k=max(30,min(1000,predetermined quantity k)) (4)

That is, the predetermined quantity k is limited to between 30 and 1000.

Please refer to the examples from Scenario 1 to Scenario 3 below.

In Scenario 1, the raw log entries LG represent normal traffic with a moderate priority. The traffic is 20 entries/3 seconds (i.e., medium traffic); the priority is “moderate”; and the total number of log entries across all groups is 5000. According to this information, the following data could be analyzed.

The flow rate coefficient rt is 0; the priority coefficient pr is 0; and the memory stress coefficient mp is 0. Further, the predetermined time n and the predetermined quantity k are determined according to the following analysis.

predetermined time n=3×(1+0±0)=3 seconds.

predetermined quantity k=30×(1+0+0)=30.

In Scenario 2, the raw log entries LG are considered high-traffic and high-priority. The traffic is 50 entries/3 seconds (i.e., high traffic); the priority is “high”; and the total number of logs across all groups is 5000. According to this information, the following could be analyzed.

The flow rate coefficient rt is 1.5; the priority coefficient pr is 0.6; and the memory stress coefficient mp is 0. Further, the predetermined time n and the predetermined quantity k are determined according to the following analysis.

predetermined time n=3×(1+1.5−0.6)=5.7 seconds.

predetermined quantity k=30×(1+1.5+0)=75.

In Scenario 3, the raw log entries LG are characterized by low traffic and high pressure. The traffic is 5 entries/3 seconds (i.e., low traffic); the priority is “normal”; and the total number of logs across all groups is 9000 (i.e., high pressure). According to this information, the following could be analyzed.

The flow rate coefficient rt is −0.5; the priority coefficient pr is 0; and the memory stress coefficient mp is 0.4, i.e., (9000−8000)/(10000−8000)×0.8=0.4. Further, the predetermined time n and the predetermined quantity k are determined according to the following analysis.

predetermined time n=3×(1+(−0.5)−0)=1.5 seconds.

predetermined quantity k=30×(1+(−0.5)+0.4)=27.

In summary, the cluster unit 120 implements raw log entry clustering through technologies such as traffic detection, dynamic parameter calculation, load control, and memory protection. In the traffic detection, the cluster unit 120 monitors the number of logs within a 5-second sliding window. In the dynamic parameter calculation, the cluster unit 120 uses algorithms to adjust parameters in real time. In the load control, the cluster unit 120 manages the processing queue to prevent overload. In the memory protection, the cluster unit 120 monitors and enforces memory limits.

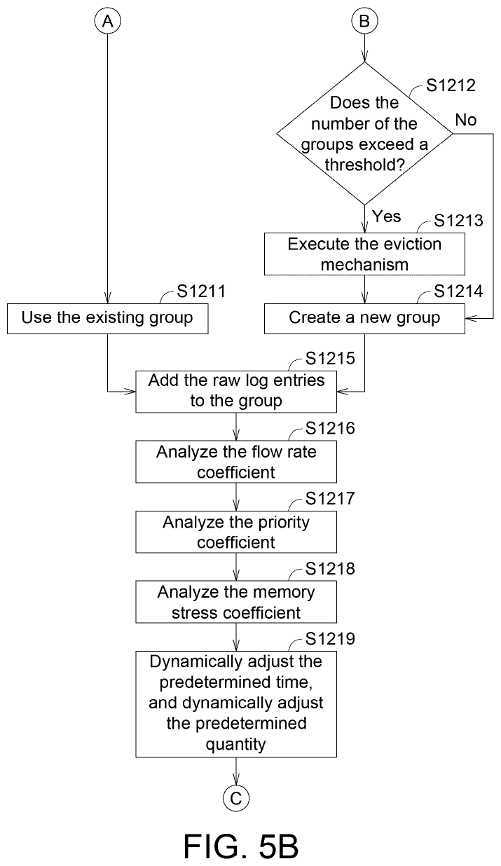

Please refer to FIGS. 5A to 5C, which illustrate a detailed flowchart of the step S120 according to an embodiment of this disclosure. This process effectively manages and clusters the raw log entries LG from multiple sources through a series of dynamic adjustment and judgment mechanisms, thereby improving the responsiveness and resource utilization efficiency of the log processing system. In the step S1201 of FIG. 5A, the system first initializes the parameters and data structures, including the group management structure, traffic statistics variables, and various trigger thresholds, to ensure a stable initial state for subsequent operations.

Next, in the step S1202 of FIG. 5A, the system trigger a regular maintenance task to perform background operations such as memory reclamation, statistical information reset, and cleanup of expired groups, in order to maintain the stability of the system's long-term operation.

Then, in the step S1203 of FIG. 5A, the system enters the standby mode, waiting for external devices or systems to continuously input the raw log entries LG, preparing data for subsequent clustering and analysis processes.

In the step S1204 of FIG. 5A, the system begins to receive the raw log entries LG and performs initial receive buffering and queue management.

Next, in the step S1205, the system extracts the source IP address and the priority information from the received log data (used to calculate the priority coefficient pr) for subsequent traffic classification, group identification, and scheduling decisions.

In the step S1206, the system updates traffic information, including the number of packets, data size, and time distribution for each source IP, as the basis for calculating the flow rate coefficient rt.

Next, in the step S1207, the system determines whether the cluster trigger conditions for “emergency trigger” are met. This determination is mainly for specific high-priority events or abnormal traffic bursts. If the conditions are met, the system will process them immediately; if not, the standard procedure will be executed.

If the cluster trigger conditions for “emergency trigger” are met, in the step S1208, the system immediately clusters the raw log entries LG into a group GP and quickly sends it to the log parsing engine 130 to meet the immediate processing requirements.

If the cluster trigger conditions for “emergency trigger” are not met, in step S1209, the system selects a candidate group GP from the existing groups for further evaluation.

In the step S1210, whether a group GP corresponding to the IP address already exists is determined. If it does, the process proceeds to step S1211 in FIG. 5B; if it does not exist, it proceeds to step S1212.

In the step S1211, the system decides to directly use the existing group GP to simplify processing and reduce memory overhead.

In the step S1212, if no groups GP corresponding to the IP address already exist, whether the number of the groups exceeds a threshold is determined in order to avoid resource exhaustion due to too many groups.

In the step S1213, if the number of the groups exceeds the threshold, the system executes the eviction mechanism to select the least recently used (LRU) group GP for deletion to free up space for new groups.

If the number of the groups does not exceed the threshold, in the step S1214, the system directly creates a new group GP to correspond to the new source IP.

Following the step S1215, the newly received raw log entries LG are added to the group GP for subsequent batch analysis.

Next, in the step S1216, the system analyzes the flow rate coefficient rt to evaluate the current data transmission rate of the source IP, so as to dynamically adjust the subsequent clustering strategy.

In the step S1217, the priority coefficient pr of the raw log is analyzed to assess the importance of the data.

In the step S1218, the system analyzes the memory stress coefficient mp to assess the current system resource pressure status.

In the step S1219, the system dynamically adjusts the predetermined time n according to the waiting time base tm0, the flow rate coefficient rt, and the priority coefficient pr, and simultaneously dynamically adjusts the predetermined quantity k according to the batch size base sz0, the flow rate coefficient rt, and the memory stress coefficient mp, in order to optimize the cluster latency and the efficiency.

Next, in the step S1220 of FIG. 5C, the system evaluates the cluster trigger conditions, including various conditions such as “quantity trigger”, “time trigger”, “idle trigger” and “stress trigger”, to determine whether to perform clustering.

If the “quantity trigger” condition is met, in the step S1221, the raw log entries LG with the waiting quantity NM larger than the predetermined quantity k will be clustered.

If the “time trigger” condition is met, in the step S1222, the raw log entries LG whose waiting time TM are larger than the predetermined time n are clustered.

If the “idle trigger” condition is met, in the step S1223, all waiting raw log entries LG are clustered when the queue count QN is less than the predetermined count.

If the “stress trigger” condition is met, in the step S1224, all waiting raw log entries LG are immediately clustered when the memory utilization RM is larger than the predetermined threshold.

In step S1225, whether the queue is full. If it is full, the process proceeds to the step S1226; if it is not full, the process proceeds to the step S1227.

In the step S1226, this group GP is marked as a process that can be delayed to reduce immediate overhead.

In the step S1227, this group GP is sent directly to the log parsing engine 130 for parsing.

The process then proceeds in parallel to steps S1228 and S1232.

In the step S1228, the group status is reset, such as resetting the counter and updating the status flag.

In the step S1232, asynchronous processing of the language model is performed to support backend deep analysis or natural language understanding.

After completing the step S1228, the process proceeds to the step S1229 to perform a memory protection check to prevent resource leaks.

Next, in the step S1230, the system checks whether the memory usage exceeds the limit. If it does, the process proceeds to the step S1231; otherwise, the process returns to the step S1203 to continue waiting for new data.

In the step S1231, clustering is forcibly triggered to alleviate memory pressure.

After the step S1232 is completed, the process proceeds to the step S1233, where the system waits for the log parsing engine 130 to complete the processing of the raw log entries LG in the group GP.

In the step S1234, once the processing of the raw log entries LG has been finished, the relevant status is updated.

In the step S1235, the queue status is updated to reflect the latest processing results.

In the step S1236, the delayed groups are processed sequentially to ensure that all data could be parsed in the end.

Through the steps S1201 to S1237, the cluster unit 120 could efficiently and dynamically cluster the raw log entries LG from different sources and with different characteristics, and achieve real-time analysis and resource optimization.

In the step S130 of FIG. 3, as shown in FIG. 2, the raw log entries LG are sequentially input into the log parsing engine 130 to output a plurality of normalized log entries NLG. Within the same group GP, these normalized log entries NLG record the same security rank RK and the same security description DS.

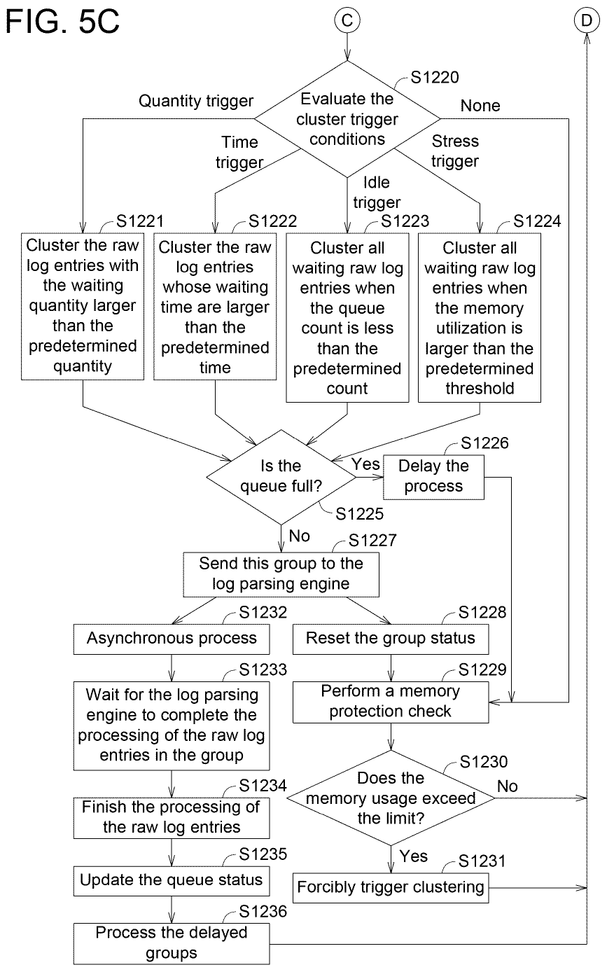

Please refer to FIG. 6, which illustrates a detailed flowchart of the step S130 according to an embodiment of this disclosure. The log parsing engine 130, for example, uses Large Language Model (LLM) and Retrieval-Augmented Generation (RAG) techniques for inference. The step S130 includes, for example, steps S131 to S137. In step S131 of FIG. 6, the log parsing engine 130 performs prompt packaging. The prompts include, but are not limited to, security analysis prompts and normalization prompts. The former is used to trigger the model to infer the Security Rank RK and Security Description DS for log data; the latter is used to guide the model to convert the final output into a specific structured or normalized format.

Specifically, the security analysis prompts include role setting (e.g., you are a security auditor/compliance expert); task description (e.g., assess risks according to established categories and policies); classification criteria/policy summary (e.g., provide actionable standards such as hate speech, violence, self-harm, personal data, malicious commands, fraud, etc.); output format (e.g., require structured output (JSON) including risk_level, categories, rationale, actions); evidence-based approach (e.g., cite fragments from the input as the basis for judgment); action recommendations (e.g., approve, mask, rewrite, reject, escalate to human review); conservative principles (e.g., when uncertain, go for a higher risk level or hand it over to human review), but are not limited to these. The normalization prompts include, but are not limited to, explicit output patterns (e.g., field name, type, allowed values); normalization rules (e.g., unit conversion, time zone, language, letter case); abbreviation expansion; error handling (e.g., assigning null or unknown to uncertain values, with accompanying notes); strict formatting (e.g., outputting only JSON, without other text); consistency (e.g., always using the same rule for the same field to avoid context drift), etc.

Next, in the step S132 in FIG. 6, tokenization and embedding are performed. For example, if the prompt word is “analysis log group, cybersecurity rating, and then regularization output”, the tokenization step will decompose the sentence into a series of tokens, such as: “analysis”, “log”, “group”, “cybersecurity”, “rating”, etc.; embedding converts these tokens into high-dimensional vectors, so that the model could not only perform pure text comparison, but also capture contextual relationships and semantic features.

Next, in the step S133 of FIG. 6, task recognition and decomposition is performed. This step includes four sub-steps: task recognition, task classifier activation, marking as single/complex tasks, and triggering the task decomposition module. Through this multi-stage process, the task flow could be refined and structured, facilitating subsequent execution and scheduling.

In the “task cognition”, the log parsing engine 130 extracts key actions from prompts, such as “analysis”, “rating” and “regularization”, and then recognizes the multi-stage processing requirements implied by the prompt.

Next, in the “task classifier activation”, the log parsing engine 130 uses its built-in task classifier to determine the task's attributes (such as analytical, generative, translational, or summarizing) and further classifies it as a single or complex task. For example, actions such as “analysis,” “rating,” and “regularization” could identify that the task involves multiple steps, thus classifying it as a complex task.

In the “marking as single/complex tasks” stage, if a task is determined to be complex, the overall goal needs to be broken down into multiple sub-tasks. For example, “analysis log groups” corresponds to the step of parsing the raw log content; “security rating” corresponds to assessing the security score of the parsed data; and “regularized output” outputs the aforementioned results in a specific format.

Next, in “triggering the task decomposition module”, the log parsing engine 130 triggers the task decomposition module, breaking down the overall task into smaller executable units, determining the execution order and dependencies, to ensure that the output of the previous step could serve as the input source for the subsequent steps. This process is similar to a project manager first scheduling the work plan and then starting to execute it in sequence.

In the step S134 of FIG. 6, the Retrieval-Augmented Generation (RAG) is performed. Since large language models may not be able to directly access internal log data or specific security rating rules, this step first converts the question or prompts into vector form, and then performs similarity searches in internal or external knowledge bases. The search results (such as log content, rating rules, format examples, etc.) are dynamically added to the prompts to provide the model with more contextual references, thereby improving inference accuracy and reducing the risk of “hallucination.”

Then, in the step S135 of FIG. 6, correlation analysis and security rating are performed. According to the enhanced retrieval content, the log parsing engine 130 performs semantic and structured analysis on the data in the log group, and then derives the corresponding security rank RK and the corresponding security description DS.

Next, in the step S136 of FIG. 6, format normalization is performed. This step will fills the corresponding target fields with the analysis and rating results according to the system-defined output template or user requirements, and finally generates the structured normalized log entries NLG.

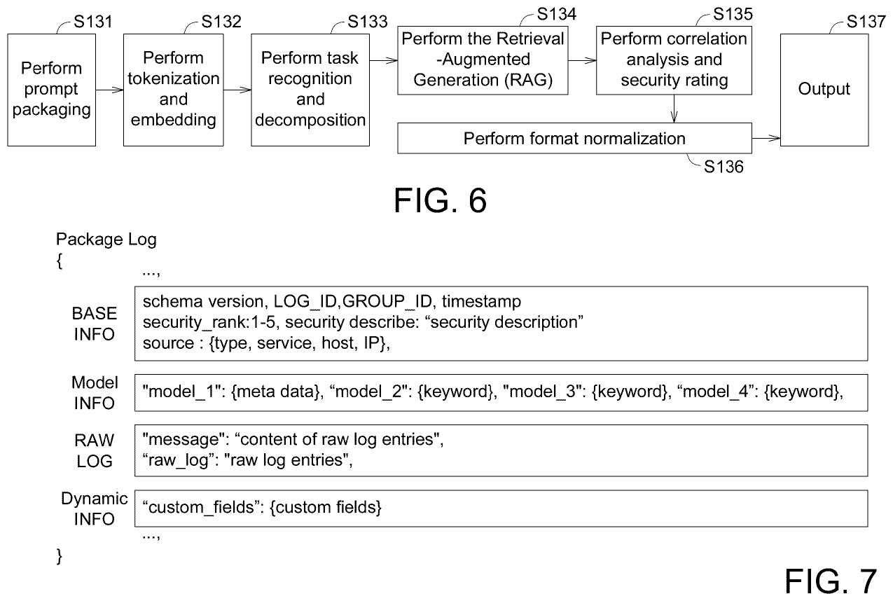

Subsequently, in the step S137 of FIG. 6, the generated normalized log entries NLG are output to the backend system or database. Within the same group GP, these log entries will share the same security rank RK and the same security description DS. For example, as shown in FIG. 7, in the normalized log entries NLG, the “security_rank” field is the inferred security rank RK, and the “security_describe” field is the corresponding security description DS.

Through the steps S131 to S137, the log parsing engine 130, when faced with raw log entries from multiple sources, could achieve high-precision and standardized security rank assessment and log normalization processing through prompt packaging, task recognition and decomposition, enhanced retrieval generation, and structured output.

Next, in the step S140 of FIG. 3, the normalized log entries NLG are stored in the log search engine 150.

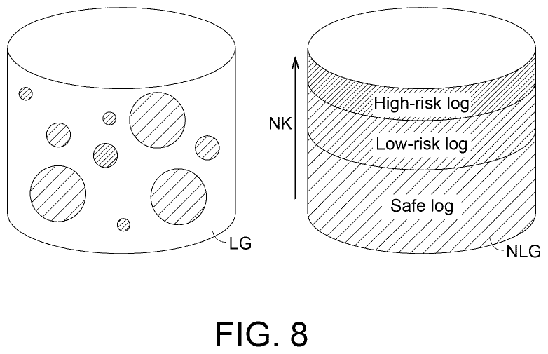

Then, in the step S150 of FIG. 3, the log search engine 150 performs a hierarchical search according to the security rank RK. For example, refer to FIG. 8, which illustrates the hierarchical structure of normalized log entries NLG. As shown on the left side of FIG. 8, the raw log entries LG lack the security rank RK and the security description DS, making them disorganized and difficult to search. In contrast, the normalized log entries NLG on the right side of FIG. 8 are provided with the security rank RK and the security description DS, enabling a hierarchical search and significantly improving search efficiency.

Next, in the step S160 of FIG. 3, the log analysis engine 160 performs hierarchical analysis according to the security rank RK.

According to the above embodiments, the log processing method and log processing system 100 disclosed herein have at least the following unexpected advantages.

The log processing method and the log processing system 100 disclosed herein could improve log processing efficiency and consistency. Through a unified and extensible log structure, regardless of the source (Syslog, AWS JSON, or other formats), standardized processing could be performed, reducing the adaptation costs of subsequent analysis systems. In addition, dynamic encapsulation and group hierarchical design ensure that log data has structure and semantic relevance before entering SIEM or other security analysis systems, improving analysis efficiency.

The log processing method and the log processing system 100 disclosed herein enhance semantic understanding and cybersecurity analysis capabilities. This technology incorporates lightweight LLMs (such as LLaMA3.2, Gemma3) for semantic parsing, enabling a more accurate understanding of log context and potential anomalous behavior compared to traditional NLP methods. Furthermore, by fine-tuning the model to adapt to multiple log source formats and a unified output format, the model's generalization ability and practicality are improved.

The log processing method and the log processing system 100 disclosed herein could reduce false positive rates and improve cybersecurity incident correlation analysis. This technology, through log slicing and grouping, could treat logs from different sources but with similar times as the same event, improving the accuracy of incident correlation analysis. Furthermore, by combining retrieval-augmentation generation (RAG) technology with a cybersecurity behavioral database, the model's knowledge could be expanded in real time, enabling dynamic analysis and description of emerging cybersecurity threats.

The log processing method and the log processing system 100 disclosed herein can perform adaptive and rapid log clustering. This technology requires no manual adjustment; the system automatically adapts to various scenarios, thus possessing adaptability. Furthermore, this technology simultaneously considers performance, immediacy, and resource constraints, thus possessing balance. Moreover, this technology uses boundary constraints to prevent extreme parameters from affecting system stability, thus possessing stability. In addition, the algorithm of this technology ensures predictable parameter changes, thus possessing predictability.

The algorithm disclosed here ensures optimal processing performance under various load conditions. For example, compared to log-by-log processing, this technology improves throughput by 3 to 5 times. Response latency for urgent events is less than 1 second; for high-priority events, the response latency is between 3 and 5 seconds; and for general logs, the response latency is between 5 and 30 seconds. Furthermore, aggregation of logs from the same source (IP address) provides a more complete attack chain analysis. Large language models could analyze a larger log context, improving detection accuracy and enabling batch processing.

Grouping reduces the false alarm rate of individual log entries, thus achieving noise reduction. Dynamic parameter adjustment smooths the process, enabling load balancing during peak traffic. Multi-level protection mechanisms prevent memory overflow, providing resource protection. Automatic degradation processing is available in case of model service anomalies, providing fault recovery capabilities.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A log processing method, comprising:
continuously obtaining a plurality of raw log entries, wherein the raw log entries originate from a plurality of sources;
clustering the raw log entries into one or more groups;
sequentially inputting the raw log entries into a log parsing engine to output a plurality of normalized log entries, wherein for each of the groups, a plurality of security ranks recorded in the normalized log entries are identical to each other and a plurality of security descriptions recorded in the normalized log entries are identical to each other; and
storing the normalized log entries in a log search engine.

2. The log processing method according to claim 1, wherein in the step of clustering the raw log entries, the raw log entries that trigger clustering originate from an identical source.

3. The log processing method according to claim 1, wherein in the step of clustering the raw log entries, a cluster trigger condition includes that an emergency keyword appears.

4. The log processing method according to claim 1, wherein in the step of clustering the raw log entries, a cluster trigger condition includes that a memory utilization is larger than a predetermined threshold.

5. The log processing method according to claim 1, wherein in the step of clustering the raw log entries, a cluster trigger condition includes that a queue count of the log parsing engine is less than a predetermined count.

6. The log processing method according to claim 1, wherein in the step of clustering the raw log entries, a cluster trigger condition includes that a waiting time of at least one of the raw log entries is greater than a predetermined time.

7. The log processing method according to claim 6, wherein the predetermined time is dynamically adjusted.

8. The log processing method according to claim 6, wherein the predetermined time is dynamically adjusted according to a waiting time base, a flow rate coefficient, and a priority coefficient.

9. The log processing method according to claim 1, wherein in the step of clustering the raw log entries, a cluster trigger condition includes that a waiting quantity of the raw log entries is greater than a predetermined quantity.

10. The log processing method according to claim 9, wherein the predetermined quantity is dynamically adjusted.

11. The log processing method according to claim 9, wherein the predetermined quantity is dynamically adjusted according to a batch size base, a flow rate coefficient, and a memory stress coefficient.

12. The log processing method according to claim 1, further comprising:
performing, by the log search engine, a hierarchical search according to the security rank.

13. A log processing system, comprising:
an input unit, configured to continuously obtain a plurality of raw log entries, wherein the raw log entries originate from a plurality of sources;
a cluster unit, configured to cluster the raw log entries into one or more groups;
a log parsing engine, configured to sequentially input the raw log entries into a log parsing engine to output a plurality of normalized log entries, wherein for each of the groups, a plurality of security ranks recorded in the normalized log entries are identical to each other and a plurality of security descriptions recorded in the normalized log entries are identical to each other; and
a log search engine, configured to store the normalized log entries.

14. The log processing system according to claim 13, wherein the raw log entries that trigger clustering originate from an identical source.

15. The log processing system according to claim 13, wherein a cluster trigger condition used for the cluster unit includes that an emergency keyword appears.

16. The log processing system according to claim 13, wherein a cluster trigger condition used for the cluster unit includes that a memory utilization is greater than a predetermined threshold.

17. The log processing system according to claim 13, wherein a cluster trigger condition used for the cluster unit includes that a queue count of the log parsing engine is less than a predetermined count.

18. The log processing system according to claim 13, wherein a cluster trigger condition used for the cluster unit includes that a waiting time of at least one of the raw log entries is greater than a predetermined time.

19. The log processing system according to claim 18, wherein the cluster unit dynamically adjusts the predetermined time.

20. The log processing system according to claim 18, wherein the cluster unit dynamically adjusts the predetermined time according to a waiting time base, a flow rate coefficient, and a priority coefficient.

21. The log processing system according to claim 13, wherein a cluster trigger condition used for the cluster unit includes that a waiting quantity of the raw log entries is greater than a predetermined quantity.

22. The log processing system according to claim 21, wherein the cluster unit dynamically adjusts the predetermined quantity.

23. The log processing system according to claim 21, wherein the cluster unit dynamically adjusts the predetermined quantity according to a batch size base, a flow rate coefficient, and a memory stress coefficient.

24. The log processing system according to claim 13, wherein the log search engine performs a hierarchical search according to the security rank.

25. A non-transitory computer-readable medium, storing a plurality of program instructions that, when executed by a processor, cause the processor to perform a method comprising:
continuously obtaining a plurality of raw log entries, wherein the raw log entries originate from a plurality of sources;
clustering the raw log entries into one or more groups;
sequentially inputting the raw log entries into a log parsing engine to output a plurality of normalized log entries, wherein for each of the groups, a plurality of security ranks recorded in the normalized log entries are identical to each other and a plurality of security descriptions recorded in the normalized log entries are identical to each other; and
storing the normalized log entries in a log search engine.
